(19) United States
(12) Patent Application Publication
(10) Pub. No.: US 2018/0322150 A1
(43) Pub. Date: Nov. 8, 2018

(54) DYNAMIC SCHEMA TYPING

(71) Applicant: ENTIT SOFTWARE LLC, SANFORD, NC (US)

(72) Inventors: Qiming Chen, Sunnyvale, CA (US); Rui Liu, Sunnyvale, CA (US); Meichun Hsu, Sunnyvale, CA (US)

(21) Appl. No.: 15/773,348

(22) PCT Filed: Nov. 4, 2015
(86) PCT No.: PCT/US2015/059055

§ 371 Date: May 3, 2018

(51) Int. Cl. G06F 17/30

(52) U.S. Cl. CPC G06F 17/30297; G06F 17/30448

(57) ABSTRACT

In one example in accordance with the present disclosure, a method for dynamic schema typing may include receiving a host query with a function defining data to be retrieved. The function may include a dynamically definable schema. The method may also include receiving, at function invocation time, a data type schema defining a type of the data to be retrieved and generating a query using the data type schema as a value for the dynamically definable schema. The method may also include retrieving the data, converting the retrieved data into a form defined by the data type schema and providing the transformed data to the host query.

### BACKGROUND

A Structured Query Language (SQL) has the expressive power for retrieving, manipulating and analyzing relational data. In order to handle application logic not directly expressible by SQL, a User Defined Function (UDF) may be used. A UDF is a function provided by the user of an environment as opposed to functions that are built into the environment.

### BRIEF DESCRIPTION OF THE DRAWINGS

The following detailed description references the drawings, wherein:

FIG. 1 is a block diagram of an example computing environment in which dynamic schema typing may be useful;

FIG. 2 is a flowchart of an example method for dynamic schema typing;

FIG. 3 is a flowchart of an example method for dynamic schema typing;

FIG. 4 is a block diagram of an example system for dynamic schema typing; and

FIG. 5 is a block diagram of an example system for dynamic schema typing.

### DETAILED DESCRIPTION

Many enterprise applications access both structured data from Relational Databases (RDBs) and unstructured data from other platforms such as Hadoop®, neo4j, Spark™, etc. SQL query may retrieve the external data directly through function-scan, a technique where a remote application queries a local database with data derived and transformed to the required form through a function. Function-scan may be handled by a User Defined Transformation Functions (UDTF) that receives and parses data from an external data source and return relation tuples to feed a hosting query.

In this manner, it is possible to connect to one or more external SQL engines from within a UDTF hosted by a query, issue SQL queries to retrieve the data from the external SQL engines and feed the result set to the host query for joint analysis. Each query, however, typically has an individual return schema, and a return schema that is specified statically at design time. In other words, one UDTF may be used for each query. As used herein, the term schema may refer to a number of returned attributes, the names of the returned attributes and types. As used herein, the term type may refer to a structural definition of data. Example types include Variable Character Field, integer, string, etc. Type may also refer to a property of the data. Example properties include the number of characters in a string, number of characters in an integer, etc.

Example dynamic schema typing systems may allow the signature of a UDTF to be assigned at function invocation time dynamically rather than design time statically. As used herein the term signature may refer to the input and output names and types of data. Because the signature is assigned dynamically, this technique may be referred to as use UDTF Dynamic Typing. Referring to the SQL examples describes above, example query generation systems may determine the input and return schema of the UDTF at run-time when the schema (name-types) of the issued SQL query, are already known. In this manner, a single UDTF can have various return types according to various SQL queries.

As described herein, a dynamically typed UDTF may be capable of handling any input and any output (both the number of values and their types). Therefore, multiple applications, such as SQL based data retrievals or Cypher based graph data retrievals, may be handled generally by a single UDTF.

An example method for dynamic schema typing may include receiving a host query with a function defining data to be retrieved, wherein the function includes a dynamically definable schema. The method may also include receiving, at a function invocation time, a data type schema defining a type of the data to be retrieved and generating a query using the data type schema as a value for the dynamically definable schema. The method may also include retrieving the data, converting the retrieved data into a form defined by the data type schema and providing the transformed data to the host query.

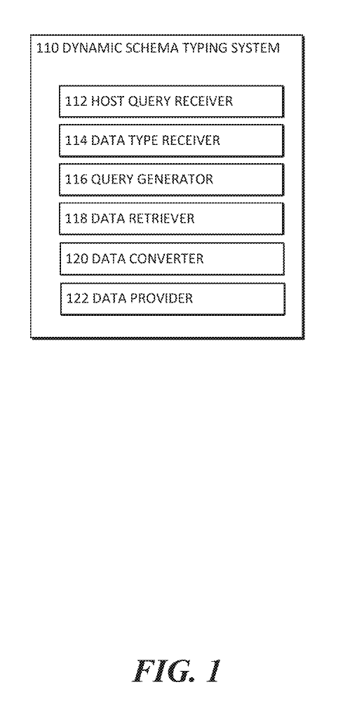

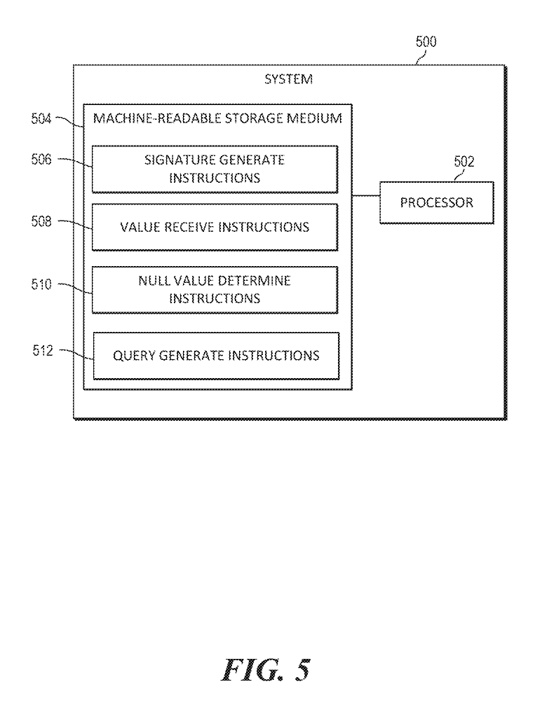

FIG. 1 is a block diagram of an example dynamic schema typing system 110. In the example shown in FIG. 1, system 110 may comprise various components, including host query receiver 112, data type receiver 114, query generator 116, data retriever 118, data converter 120, data provider 122 and/or other components. According to various implementations, dynamic schema typing system 110 may be implemented in hardware and/or a combination of hardware and programming that configures hardware. Furthermore, in FIG. 1 and other Figures described herein, different numbers of components or entities than depicted may be used. As is illustrated with respect to FIG. 5, the hardware of the various components of dynamic schema typing system 110, for example, may include one or both of a processor and a machine-readable storage medium, while the instructions are code stored on the machine-readable storage medium and executable by the processor to perform the designated function.

Host query receiver 112 may receive a host query. A host query may be a request for information from a data source. The host query may include a function, such as a user defined transformation function (UDTF). The function may define data to be retrieved and may include a dynamically definable schema.

A UDTF function instance may be created by a function factory, such as a UDTF factory. A function factory may be software used to create a function. In some examples, the function factory, rather than the UDTF itself, may be registered before the function (i.e. the UDTF instance) to be invoked. By registering the function factory rather than the UDTF itself, return types can be binded at the UDTF instance creation time. An example host query with a UDTF may look something like what is shown in Table 1 below.

TABLE 1
SELECT movie_title, year FROM
(SELECT cypherUdx(‘Tom Hanks’ USING PARAMETERS
servers=‘http://lava-42:7474/db/data/’,
cypher=‘MATCH (actor:Person {name: “%1”})-[:ACTED_IN]->(movies)
RETURN movie.title, movies.released as year’
sch=‘movie_title:string(128),year:int’) OVER( )) f;

The example host query of table 1 includes an example UDTF named “CypherUdx.” CypherUdx may inherit from an abstract UDTF class, add the specific ability to connect to a neo4j graph database server to the abstract UDTF class and invoke a specified graph query. CypherUdx may retrieve a neo4j graph database using the Cypher graph query language, and transforms the host query result to relational form to return to a SQL query. The example host query of table 1 is an example only and other host queries may be used along with different types of data sources, query languages and functionalities.

Data type receiver 114 may receive a data type schema defining a type of the data to be retrieved. Data type receiver 114 may receive the data type schema at function invocation time. Turing again to the example host query of table 1, the example UDTF “CypherUdx” has its return schema (represented as “sch”) dynamically defined as ‘movie_title:string(128),year:int’ by having the value for the return schema passed in as a parameter at the invocation time, rather than defined statistically. In other words, the type binding is made at run-time. Type binding is a process where a variable is bound to a type. By dynamically defining the schema at invocation time, the same UDTF can be used to handle different queries with different return schemas. In this manner the generic interface represented by the variable “sch” allows any number of input and return data schema to be accommodated.

Data type receiver 114 may also receive a second data type schema defining a second type of the data to be retrieved. The data type schema and the second data type schema are different.

For example, a separate host query can invoke a UDTF and provide a return schema for the UDTF. Because the schema is dynamically defined at invocation time, a return schema that is different than the original return schema can be passed to the UDTF. An example host query that invokes the UDTF CypherUDx (i.e. as discussed in regards to Table 1) and provides a new return schema may look something like what is shown in Table 2 below.

TABLE 2

Select cypherUdx (director, movie_title using
parameters role=1,sch=‘director:string(20), movie_title:string(64),’)
over (partition best) FROM doc_index;

The example host query of table 2 invokes cypherUDx but may provide a different return schema than what was originally used. CypherUDx originally (i.e. as depicted in the example host query of table 1) may have a return schema defined as ‘movie_title:string(128),year:int,” and the return schema may be changed at invocation time. As depicted in the example host query of table 2, the return schema of cypherUDx may be statically defined as ‘director:string(20), movie_title:string(64).” In this manner, a UDTF, such as the UDTF cypherUDx depicted in the example host queries of tables 1 and 2, can be used for data sources with different return schema without having to generate an entirely new UDTF.

Query generator 116 may generate a query using the data type schema as a value for the dynamically definable schema. Query generator 116 may also generate a second query using the second data type schema as a value for the dynamically definable schema When a query is created, such as a SQL query, an input type may be defined as “any” and the return name and return type may not be specified. Instead, a parameter defining the data type schema may be provided at invocation time.

In one example, an object for the return schema may be defined when the UDTF factory class is created. The object may initially be set to null. The query generator 116 may determine that a return schema is set to null before generating the query using the data type schema as a value for the dynamically definable schema.

Query generator 116 may also be used to support peer-to-peer data retrieval, by making multiple parallel data retrieval streams. Each data retrieval stream may gather local data from one node in a cluster. A single UDTF may be used to support such peer-to-peer data transfer with different host queries defining different return schema for different tables.

Data retriever 118 may receive the data. The data may be retrieved from multiple sources. The sources may be structured and/or unstructured data sources. Example data sources include relational databases, Hadoop®, neo4j. Spark data sources, etc. The data may be in a format native to the database. For example, data retriever 118 may perform an SQL query including the function and the data type schema.

However, the retrieved data may not be in the format specified by the host query. Data converter 120 may convert the received data into a form defined by the data type schema. Data provider 122 may provide the transformed data to the host query.

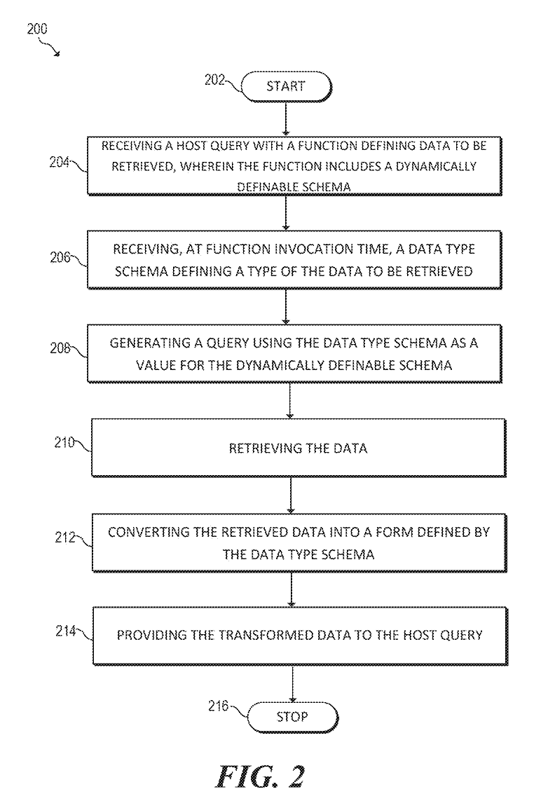

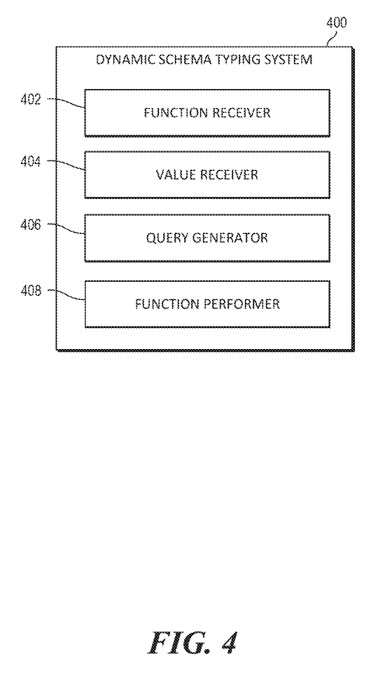

FIG. 2 is a flowchart of an example method 200 for dynamic schema typing. Method 200 may be described below as being executed or performed by a system, for example, system 110 of FIG. 1, system 400 of FIG. 4 or system 500 of FIG. 5. Other suitable systems and/or computing devices may be used as well. Method 200 may be implemented in the form of executable instructions stored on at least one machine-readable storage medium of the system and executed by at least one processor of the system. Alternatively or in addition, method 200 may be implemented in the form of electronic circuitry (e.g., hardware). The steps of method 200 may be executed substantially concurrently or in a different order than shown in FIG. 2. Method 200 may include more or less steps than are shown in FIG. 2. The steps of method 200 may, at certain times, be ongoing and/or may repeat.

Method 200 may start at step 202 and continue to step 204, where the method may include receiving a host query. The host query may include a function defining data to be retrieved. The function may be created by a factory, such as a User Defined Transformation Factory. The User Defined Transformation Factory may be registered before the function is invoked. The function may include a dynamically definable schema. The dynamically definable schema may initially be set to a null value. The dynamically definable schema may define a property of the data. At step 206, the method may include receiving, at function invocation time, a data type schema defining a type of the data to be retrieved. At step 208, the method may include generating a query using the data type schema as a value for the dynamically definable schema. At step 210, the method may include retrieving the data. The data may be retrieved from a structured and/or an unstructured data source. At step 212 the method may include converting the retrieved data into a form defined by the data type schema. At step 214, the method may include providing the transformed data to the host query. Method 200 may eventually continue to step 216, where method 200 may stop.

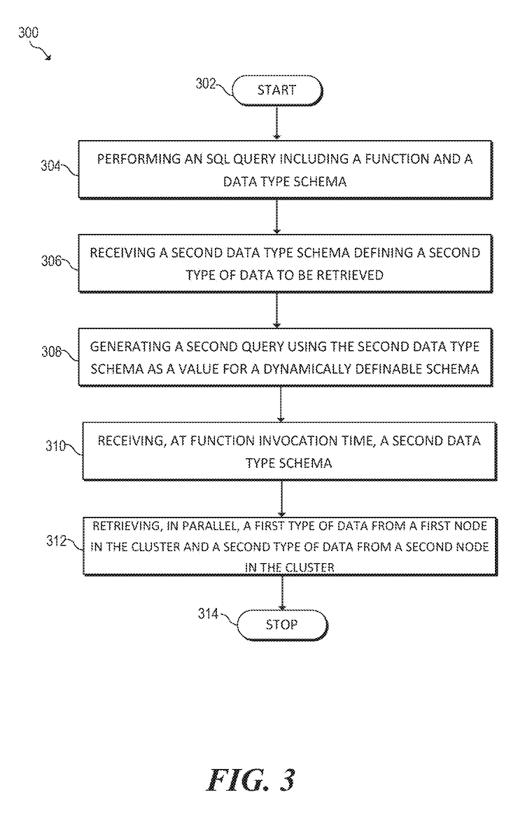

FIG. 3 is a flowchart of an example method 300 for dynamic schema typing. Method 300 may be described below as being executed or performed by a system, for example, system 110 of FIG. 1, system 400 of FIG. 4 or system 500 of FIG. 5. Other suitable systems and/or computing devices may be used as well. Method 300 may be implemented in the form of executable instructions stored on at least one machine-readable storage medium of the system and executed by at least one processor of the system. Alternatively or in addition, method 300 may be implemented in the form of electronic circuitry (e.g., hardware). The steps of method 300 may be executed substantially concurrently or in a different order than shown in FIG. 3. Method 300 may include more or less steps than are shown in FIG. 3. The steps of method 300 may, at certain times, be ongoing and/or may repeat.

Method 300 may start at step 302 and continue to step 304, where the method may include performing an SQL query including a function and a data type schema. At step 306, the method may include receiving a second data type schema defining a second type of data to be retrieved. The data type schema and the second data type schema may be different. At step 308, the method may include generating a second query using the second data type schema as a value for the dynamically definable schema. At step 310, the method may include receiving, at function invocation time, a second data type schema. The second data type schema may define a second type of data to be retrieved from a second node in a cluster. At step 312 the method may include retrieving, in parallel, a first type of data from a first node in the cluster and second type of data from the second node in the cluster. The data type schema may define the first node in the cluster. Method 300 may eventually continue to step 314, where method 300 may stop.

FIG. 4 is a block diagram of an example dynamic schema typing system 400. System 400 may be similar to system 110 of FIG. 1, for example. In the example shown in FIG. 4, system 400 includes function receiver 402, value receiver 404, query generator 406 and function performer 408.

Function receiver 402 may receive a function. The function may be created by a function factory. The function may define data to be retrieved. The function factory may be registered before the function is invoked. The function may include a schema variable. The schema variable may initially be set to a null value. The schema variable may define a property of the data.

Function receiver 402 may be implemented in the form of executable instructions stored on at least one machine-readable storage medium of system 400 and executed by at least one processor of system 400. Alternatively or in addition, function receiver 402 may be implemented in the form of a hardware device including electronic circuitry or in a firmware executed by a processor for implementing the functionality of function receiver 402.

Value receiver 404 may receive, at run time, a type value for the schema variable, wherein the type value defines a type of data. Value receiver 404 may be implemented in the form of executable instructions stored on at least one machine-readable storage medium of system 400 and executed by at least one processor of system 400. Alternatively or in addition, value receiver 404 may be implemented in the form of a hardware device including electronic circuitry or in firmware executed by a processor for implementing the functionality of character value receiver 404.

Query generator 406 may dynamically generate an SQL query using the type value as the schema variable for the function. Query generator 406 may be implemented in the form of executable instructions stored on at least one machine-readable storage medium of system 400 and executed by at least one processor of system 400. Alternatively or in addition, query generator 406 may be implemented in the form of a hardware device including electronic circuitry for implementing the functionality of query generator 406.

Function performer 408 may perform the function using the type value. Function performer 408 may be implemented in the form of executable instructions stored on at least one machine-readable storage medium of system 400 and executed by at least one processor of system 400. Alternatively or in addition, function performer 408 may be implemented in the form of a hardware device including electronic circuitry or in firmware executed by a processor for implementing the functionality of function performer 408.

FIG. 5 is a block diagram of an example system 500 for dynamic schema typing. In the example shown in FIG. 5, system 500 includes a processor 502 and a machine-readable storage medium 504. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 502 may be one or more central processing units (CPUs), microprocessors, and/or other hardware devices suitable for retrieval and execution of instructions stored in machine-readable storage medium 504. In the example shown in FIG. 5, processor 502 may fetch, decode, and execute instructions 506, 508, 510 and 512 to perform dynamic query generaton. As an alternative or in addition to retrieving and executing instructions, processor 502 may include one or more electronic circuits comprising a number of electronic components for performing the functionality of one or more of the instructions in machine-readable storage medium 504. With respect to the executable instruction representations (e.g., boxes) described and shown herein, it should be understood that part or all of the executable instructions and/or electronic circuits included within one box may be included in a different box shown in the figures or in a different box not shown.

Machine-readable storage medium 504 may be any electronic, magnetic, optical, or other physical storage device that stores executable instructions. Thus, machine-readable storage medium 504 may be, for example, Random Access Memory (RAM), an Electrically-Erasable Programmable Read-Only Memory (EEPROM), a storage drive, an optical disc, and the like. Machine-readable storage medium 504 may be disposed within system 500, as shown in FIG. 5. In this situation, the executable instructions may be “installed” on the system 500. Alternatively, machine-readable storage medium 504 may be a portable, external or remote storage medium, for example, that allows system 500 to download the instructions from the portable/external/remote storage medium. In this situation, the executable instructions may be part of an “installation package”. As described herein, machine-readable storage medium 504 may be encoded with executable instructions for dynamic schema typing.

Referring to FIG. 5, signature generate instructions 506, when executed by a processor (e.g., 502), may cause system 500 to generate a signature. The signature may include an object for a schema and the object may initially be set to a null value. The signature may include or be part of a function defining data to be retrieved. The function and/or signature may be created by a function factory. The function factory may be registered before the function is invoked. The schema may define a property of the data.

Value receive instructions 508, when executed by a processor (e.g., 502), may cause system 500 to receive a value for the object. The value may define a type of data. Null value determine instructions 510, when executed by a processor (e.g., 502), may cause system 500 to determine that the object in the signature is set to the null value. Query generate instructions 512, when executed by a processor (e.g., 502), may cause system 500 to generate a query using the value for the object in the signature. The query may be generated dynamically at invocation time.

The foregoing disclosure describes a number of examples for dynamic schema typing. The disclosed examples may include systems, devices, computer-readable storage media, and methods for dynamic schema typing. For purposes of explanation, certain examples are described with reference to the components illustrated in FIGS. 1-5. The functionality of the illustrated components may overlap, however, and may be present in a fewer or greater number of elements and components. Further, all or part of the functionality of illustrated elements may co-exist or be distributed among several geographically dispersed locations. Further, the disclosed examples may be implemented in various environments and are not limited to the illustrated examples.

Further, the sequence of operations described in connection with FIGS. 1-5 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples.

1. A method for dynamic schema typing, the method comprising:
receiving a host query with a function defining data to be retrieved, wherein the function includes a dynamically definable schema;
receiving, at a function invocation time, a data type schema defining a type of the data to be retrieved;
generating a query using the data type schema as a value for the dynamically definable schema;
retrieving the data;
converting the retrieved data into a form defined by the data type schema; and
providing the transformed data to the host query.

2. The method of claim 1, wherein the dynamically definable schema is initially set to a null value.

3. The method of claim 1, further comprising:
performing an SQL query including the function and the data type schema.

4. The method of claim 1, further comprising:
receiving a second data type schema defining a second type of the data to be retrieved, wherein the data type schema and the second data type schema are different; and
generating a second query using the second data type schema as a value for the dynamically definable schema.

5. The method of claim 1, further comprising:
retrieving the data from an unstructured data source.

6. The method of claim 1, wherein the function is created by a User Defined Transformation Factory.

7. The method of claim 1, wherein the data type schema further defines a first node in a cluster, the method further comprising;
receiving, at the function invocation time, a second data type schema, wherein the second data type schema defines a second type of data to be retrieved from a second node in the cluster; and
retrieving, in parallel, the first type of data from the first node in the cluster and second type of data from the second node in the cluster.

8. A system for dynamic schema typing, the method comprising:
a function receiver to receive a function with a schema variable, wherein the function is created by a function factory;
a value receiver to receive, at run time, a type value for the schema variable, wherein the type value defines a type of data;
a query generator to dynamically generate an SQL query using the type value as the schema variable for the function; and
a function performer to perform the function using the type value.

9. The system of claim 8, wherein the function factory is registered before the function is invoked.

10. The system of claim 8, wherein the type value further defines a property of the data.

11. The system of claim 8, wherein the dynamically definable schema is initially set to a null value.

12. A non-transitory machine-readable storage medium comprising instructions executable by a processor of a computing device for dynamic schema typing, the machine-readable storage medium comprising instructions to:
generate a signature including an object for a schema, wherein the object is initially set to a null value;
receive a value for the object, wherein the value defines a type of data;
determine that the object in the signature is set to the null value; and
generate, dynamically at invocation time, a query using the value for the object in the signature.

13. The non-transitory machine-readable storage medium of claim 12 further comprising instructions to:
receive a second value defining a second type of the data to be retrieved, wherein the data type schema and the second data type schema are different; and
generating a second query using the second data type schema as a value for the dynamically definable schema.

14. The non-transitory machine-readable storage medium of claim 12 further comprising instructions to:
retrieve the data from an unstructured data source.

15. The non-transitory machine-readable storage medium of claim 12, wherein the signature is created by a function factory.
